(19) United States
(12) Patent Application Publication
(10) Pub. No.: US 2018/0328085 A1
(43) Pub. Date: Nov. 15, 2018

(54) ACCELERATION SENSOR ASSEMBLY FOR AN AUTOMOBILE

(71) Applicant: MOTHERSON AUTOMOTIVE TECHNOLOGIES & ENGINEERING (A DIVISION OF MOTHERSON SUMI SYSTEMS LTD.), Noida, Uttar Pradesh (IN)

(72) Inventor: In Muk PARK, Yeonsu-Gu, Incheon (KR)

(21) Appl. No.: 15/983,880

(22) PCT Filed: Nov. 16, 2016
(86) PCT No.: PCT/IB2016/056889

§ 371 Date: May 18, 2018

(30) Foreign Application Priority Data
Nov. 18, 2015 (IN) 3769/DEL/2015

(51) Int. Cl. E05B 77/06; E05B 85/16; E05B 83/36; B60J 5/04

(52) U.S. Cl. CPC E05B 77/06; B60J 5/04; E05B 83/36; E05B 85/16

(57) ABSTRACT

An acceleration sensor assembly preventing opening of a door in response to an unusual force acting on a moving vehicle includes a stepped pin integrated with an amount of weight, at least two springs encapsulating the stepped pin while allowing free movement of the stepped pin, and a case cover with an opening at one side, the case cover enclosing the stepped pin and the at least two springs, where the unusual force is configured to cause acceleration of a vehicle door handle and trigger compression of the at least two springs, movement of the stepped pin out of the case cover, rotation of a bell crank due to pulling of the vehicle door handle, and insertion of the stepped pin into the bell crank to stop its further rotation thereby preventing opening of the door.

### CROSS-REFERENCE TO RELATED APPLICATIONS

This application is a national stage entry of International Patent Application No. PCT/IB2016/056889, filed Nov. 16, 2016, which claims the benefit of foreign priority to Indian Patent Application No. IN 3769/DEL/2015, filed Nov. 18, 2015, each of which is herein incorporated by reference in its entirety for all purposes.

### BACKGROUND

### 1. Field of the Invention

The following description relates to a vehicle door handle assembly. For example, a door handle assembly including an acceleration sensor assembly for avoiding undesirable opening of doors.

### 2. Description of Related Art

Vehicle and automobile doors typically include a locking mechanism intended to prevent acceleration forces from occurring during an accident leading to undesirable or unexpected opening of a door handle. This results in significant risks for a user in the vehicle. Further, when a vehicle door is unlocked in an operating vehicle, the side impact may result in inertial movement of the door handle to its unlatched position with consequent unlatching of the latch mechanism. This results in opening of the door and consequent discharge of unbuckled vehicle passengers from the vehicle. Thus, the doors are required to be securely locked so that they remain closed during the accidental impacts or during the sharp turns on the roads.

Certain scenarios where vehicle doors are accidently opened are illustrated in FIGS. 1, 2 and 3. For instance, FIG. 1 illustrates an example where a side impact during an accident results in opening of a closed door due to the Newton's reaction force. FIG. 2 illustrates another scenario where during sharp turns on the road, a door of an automobile gets unlatched due to the centrifugal force acting from the self-inertia of the doors which results in danger to the passenger including falling from the automobile. FIG. 3 further illustrates the combined scenarios of the above described examples, where the side impact and an impact produced by a sharp turn result in a high counter-reaction force, which is worst case then any of the above cases.

Various efforts have been made in order to prevent such inadvertent unlatching/opening of the vehicle doors during sharp turns, side impacts or other instances including acceleration of the vehicle, unusual forces acting on the moving vehicle such as newton force, centripetal force, etc. One such conventional method includes the use of a counterweight arrangement where a pre-calculated amount of weight is assembled as a part of the door handle assembly such that the centripetal force in turn prevents inadvertent opening of the door. However, such counterweight arrangements in door handle assemblies are often not efficient since they are heavy and add to the weight of the automobile. This results in decreasing the efficiency of the automobile. In addition, counterweight arrangements are difficult to install in the vehicle. Further, certain conventional techniques are focused on providing a door latch apparatus that prevents the opening of doors during collision of the vehicle. However, such techniques are limited in providing safety to the users.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, at least one object is to provide an effective and reliable device to effectively respond against impacts caused by accidents, sharp turns, etc. to significantly reducing the intensity of damage. Thus, an acceleration sensor with enhanced parameters such as cost effectiveness, convenience, strength, etc., is described.

In an aspect, an acceleration sensor assembly prevents opening of a door when an unusual force acts on a moving vehicle. More particularly, the acceleration sensor assembly may include a stepped pin integrated with a predetermined amount of weight; at least two springs encapsulating the stepped pin while allowing free movement of the stepped pin; a case cover with an opening at one side, where the case cover encloses the stepped pin and said at least two springs. Further, the unusual force causes acceleration of a vehicle door handle, where the acceleration of a vehicle door handle triggers the events includes: compression of the at least two springs; movement of the stepped pin out of the case cover; rotation of a bell crank due to pulling of the vehicle door handle and insertion of the stepped pin into the bell crank to stop its further rotation, thereby preventing opening of the door.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 is a diagram illustrating a side impact during an accident that results in opening of a closed door due to the Newton's reaction force.

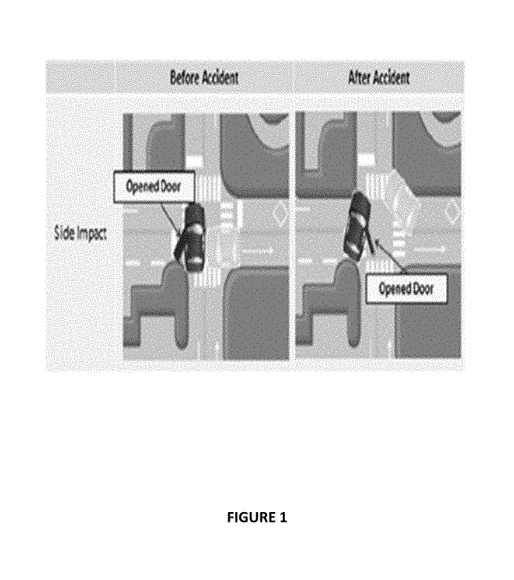

FIG. 2 is a diagram illustrating centrifugal force acting from the self-inertia of the doors where during sharp turns on the road, the door of an automobile gets unlatched.

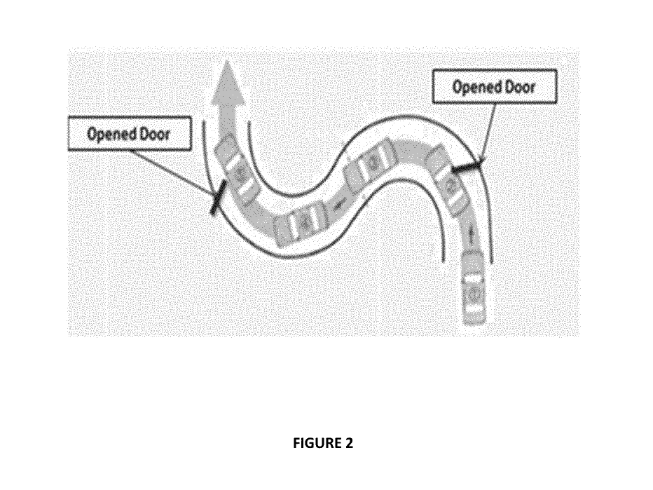

FIG. 3 is a diagram illustrating the combined effect of side impact and centrifugal force resulting in a high counter-reaction force.

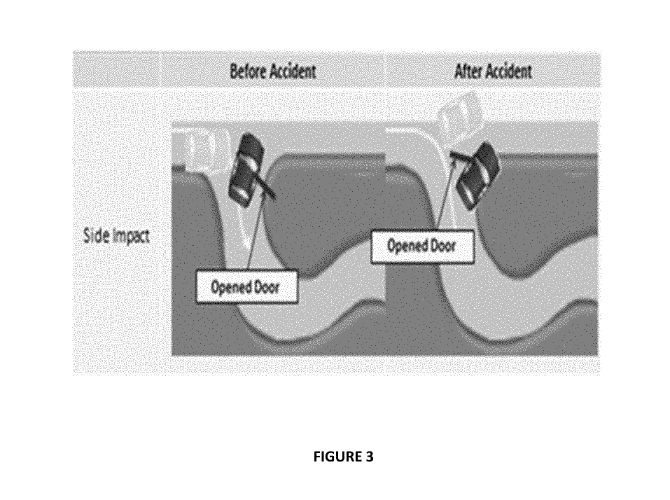

FIG. 4 is a diagram illustrating a sectional view of an example of the components within the acceleration sensor assembly.

FIG. 5 is a diagram illustrating an example of the acceleration sensor assembly.

FIG. 6 is a diagram illustrating the working of the acceleration sensor assembly along with the orientation of the same during instances of the impacts.

FIG. 7 is a diagram illustrating an example of a bell crank.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

As used herein, a “vehicle” may refer to any four wheeler (having external doors) such as a car, bus, van or any such vehicle as may be obvious to person skilled in the art. The terms “vehicle” and “automobile” have been interchangeably used in the entire specification.

As used herein, “impact” may refer to a high force/reaction force/shock occurring during a collision of two or more bodies, where the forces are relatively large contact forces acting over a short interval of time. Such impact blocks any motion of the door handle and/or the coupling unit such that an operation of the lock is prevented or hindered. More particularly, such impact includes a side force, a back force, a front force or combination thereof.

As used herein, a “bell crank” may refer to a simple device that is used to change the direction of movement through any angle varying from 0 to 360 degrees. Further, the bell crank may be subjected to large amount of stress.

As used herein, a “door handle assembly” may refer to a door handle including various elements (lever, A-sensor, etc.) supported by a vehicle door. The door handle assembly may be configured to act as a locking device that automatically maintains a locked state of the door during an accident/impact/collision. Further, the vehicle door handle may be a simple door handle or a smart door handle, where the smart door handle is configured to operate/work without the use of a key that allows the pull of door handle thereby allowing the opening of the vehicle door. Furthermore, the door handle assembly may include an outer handle that is movably mounted on the door handle assembly for opening the vehicle door by a user, where the outer handle includes an outer portion facing the user and an inner leg. In an exemplary embodiment, the inner leg is elongated and flat in nature and may include a supporting surface on the one of its lateral sides. As used herein, a “vehicle door” and “door” have been interchangeably used in the entire specification.

As used herein, an “acceleration sensor” may refer to a sensor capable of sensing/detecting and/or countering to an input from the physical environment, where the input may include, but is not limited to, an impact and impact force. The terms “acceleration sensor” and “A-sensor” have been interchangeably used in the entire specification.

As used herein, a “threshold value” may refer to a value determined on the basis of various parameters including, but not limiting to, acceleration force i.e. ‘g’, wherein said “g’ force has a scientific value of 9.8 metre per second square (9.8 m/s²). The threshold values may be required to determine which of the devices (door handle assembly or A-sensor) will perform the operation of latching/unlatching of the vehicle door handle.

As used herein, “connect”, “configure”, “attach”, “support” and each of their cognate terms, such as “connects”, “connected”, “configured”, “coupled”, “attached”, “supports”, “supporting” may include an operational and physical connection or any other suitable connection as may be obvious to a skilled person.

Acceleration Sensor Assembly

An efficient acceleration sensor assembly may be incorporated in vehicle door's for preventing the opening of doors during accidents/impacts. More particularly, an acceleration sensor assembly may lock the door handle in a fixed position thereby securely and automatically maintaining its locked state in the event of any accident/impact. The door handle assembly may include an outer handle for opening the door; a lever and an acceleration sensor (A-sensor), where the lever and the A-sensor are placed on the inner side of the door.

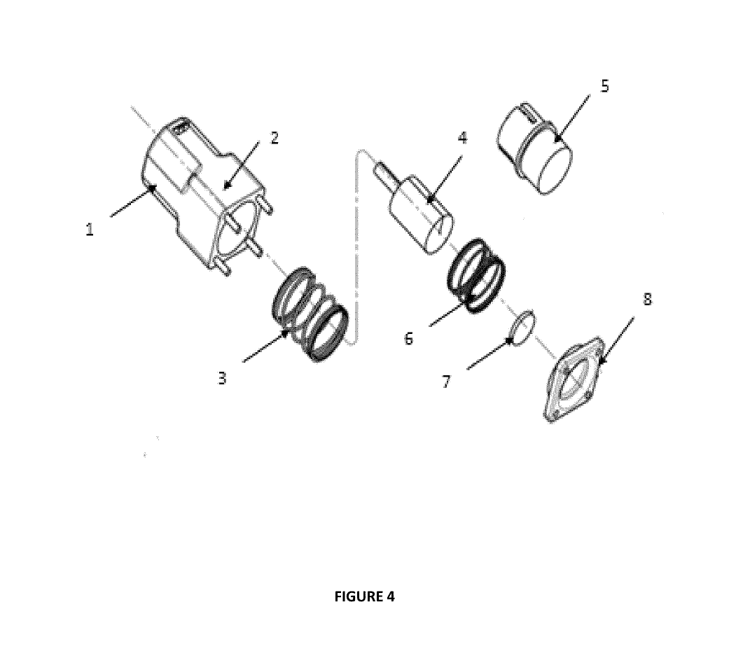

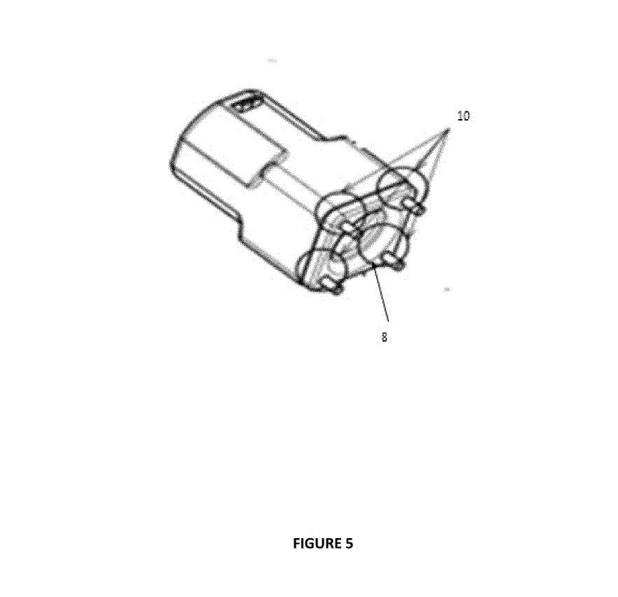

Referring to FIG. 4 and FIG. 5, FIG. 4 illustrates a sectional view of the components within the acceleration sensor assembly 1 and FIG. 5 illustrates the acceleration sensor assembly 1. The acceleration sensor assembly 1 includes a stepped pin 4; at least two springs 3, 6 encapsulating the stepped pin 4 and a case cover 2 with an opening at one side for enclosing the stepped pin 4 and the at least two springs [3, 6]. In addition, the acceleration sensor assembly 1 may include at least one housing cover 8 for covering the acceleration sensor assembly 1 along with a cushion pad 7 and a heat staking element 10.

The stepped pin 4 of the acceleration sensor assembly 1 may include a base body and an engaging means protruding out from one end of the base, where the diameter of the engaging means is lesser than that of the base. In an example, the stepped pin 4 may be adapted to have variable thickness along its length; however it is preferred that the stepped pin 4 is thinner towards the front end and thicker towards the rear end. The stepped pin 4 may be integrated with a predetermined amount of weight, where the amount of weight depends on acceleration requirement of the vehicle. Thus, ‘g’ force plays a critical role in determining the amount of weight. For example, with the increase in ‘g’ force, the balance weight has to be increased in order to suffice with the requirement of the stepped pin 4. In an example, the balance weight is increased by increasing the diameter of the stepped pin 4 while in another example, the balance weight is increased by making the cover of the stepped pin 4 of a synthetic material including plastic, polyethylene or any such material.

The at least two springs 3, 6 may encapsulate the stepped pin 4 of the acceleration sensor assembly 1 while allowing free movement of the stepped pin 4. The at least two springs 3, 6 may be configured to efficiently support the working/functionality of the acceleration sensor assembly 1.

The case cover 2 may encloses the stepped pin 4 and the at least two springs 3, 6. The case cover 2 may further include an opening at one side. Additionally, the case cover 2 may be prepared from plastic or any such material as may be obvious to a person skilled in the art. In an exemplary embodiment of the present invention, the case cover 2 may have a shape such as cuboidal, rectangular or any such shape.

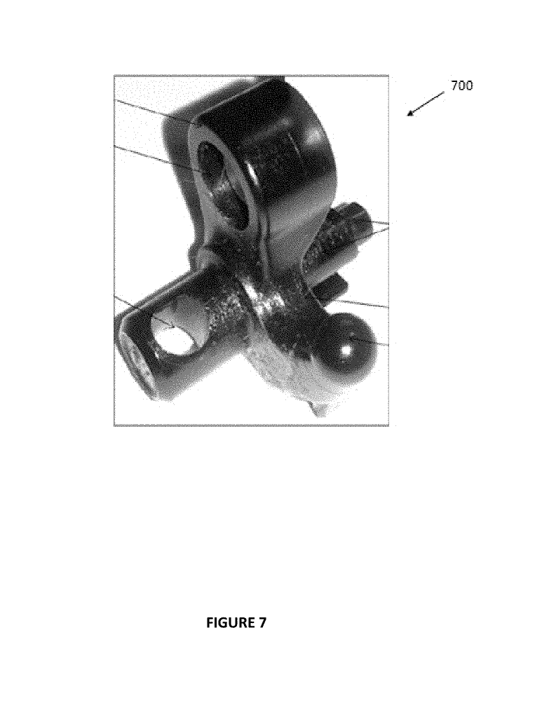

In addition, the bell crank 700, as illustrated in FIG. 7, may be configured with the acceleration sensor assembly 1 to enable the working/functionality of the acceleration sensor assembly 1.

Though the acceleration sensor assembly 1, for preventing the undesirable opening of the vehicle door during an impact, as illustrated in FIG. 4 shows different components for performing different tasks, it will be appreciated by persons skilled in the art that the present invention is not limited to the components shown in said figure and one or more components may be used.

Method Overview

As a part of the process of preventing the undesirable opening of the vehicle door, the value of ‘g’ force may be determined. The unusual force causes acceleration of a vehicle door handle 402, where the unusual force may include newton force or centripetal force. Thus, in an example, when ‘g’ force (exerted due to the impact) exceeds a threshold value, then the working of the acceleration sensor assembly 1 may be triggered. The threshold value may be pre-defined by the user or the system and the minimum value of the threshold value may be 9.8 m/s². On the contrary, the value of ‘g’ force below the threshold value may allow the acceleration sensor assembly 1 to return to its original state and thus, the acceleration sensor assembly 1 does not actuate thereby facilitating normal functioning for the door handle assembly where the door handle assembly operates during latching and unlatching. In such instances, at least one of the springs 3, 6 ensures that the working of the acceleration sensor assembly 1 is not triggered.

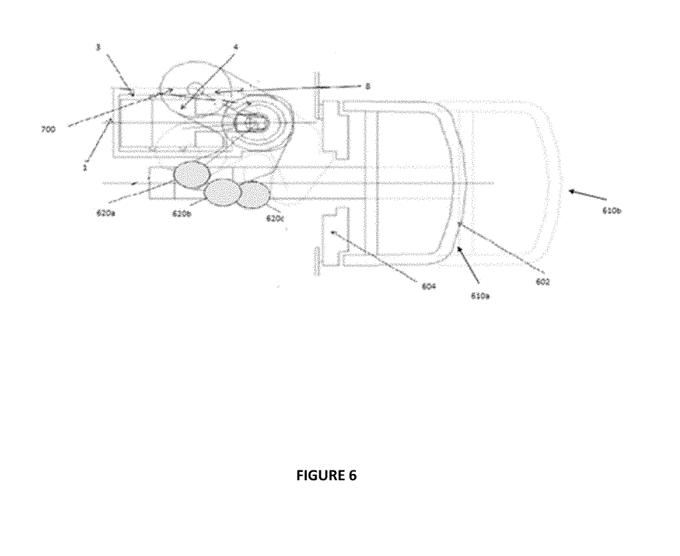

FIG. 6 illustrates an example of the workings of the acceleration sensor assembly 1 during instances including, but not limiting to, accidental impact and sharp turns. FIG. 6 further illustrates the orientation/alignment of the door handle assembly where the vehicle door is operatively coupled to at least one of the acceleration sensor assembly 1, bell crank 700 and combinations thereof. Typically, the movement of opening and/or closing the door at the door handle assembly includes, but is not limited to, pulling and/or pushing motion of the door handle 602. The outer handle 602 switches from a resting position 620c into an operating position 620b, with the respective motion of the door handle 602 being mechanically transferred via the bell crank 700, illustrated at locking position 620a. Further, two positions 610a, 610b of the outer handle 602 are illustrated, one position being that of the handle during the side impact (due to accident or sharp turn) while the other being that of the normal position of the door handle with respect to the door panel 604 in a latched condition. Also, the outer handle 602 may be adapted to get pulled outwards to unlatch the door during the impact.

Acceleration of the vehicle door handle 402 may trigger at least one of the following steps/events when ‘g’ exceeds a threshold value. Initially, the at least two springs 3, 6 compresses where at least one spring is compressed.

Further, the stepped pin 4 may move out from the case cover 2 followed by rotation of the bell crank 700 due to the pulling of the vehicle door handle. Furthermore, insertion of the stepped pin 4 into the bell crank 700 may tend to stop the further rotation of the bell crank 700, thereby preventing the opening of the vehicle door. Thus, the vehicle door may remain latched even when the impact force reaches above the threshold.

However, a person skilled in the art may appreciate that security systems vary from vehicle to vehicle for efficient results/outcomes. Thus, an acceleration sensor assembly 1 avoids undesirable opening of a vehicle door not only during side impacts or impacts from sharp turns but also during non-side impacts caused by other factors. Among other advantages, the acceleration sensor assembly 1 not only overcomes drawbacks of the conventional arts but also provides an efficient and enhanced security and reliability.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

1-7. (canceled)

8. An acceleration sensor assembly for preventing opening of a door in response to an unusual force acting on a moving vehicle, the acceleration sensor assembly comprising:
a stepped pin integrated with an amount of weight;
at least two springs encapsulating the stepped pin while allowing free movement of the stepped pin; and
a case cover with an opening at one side, the case cover enclosing the stepped pin and the at least two springs,
wherein, the unusual force is configured to cause acceleration of a vehicle door handle and trigger compression of the at least two springs, movement of the stepped pin out of the case cover, rotation of a bell crank due to pulling of the vehicle door handle, and insertion of the stepped pin into the bell crank to stop its further rotation thereby preventing opening of the door.

9. The acceleration sensor assembly of claim 1, further configured with at least one of a simple door handle or a smart door handle.

10. The acceleration sensor assembly of claim 1, wherein the unusual force comprises at least one of a newton force or a centripetal force.

11. The acceleration sensor assembly of claim 1, wherein the amount of weight is based on an acceleration requirement of the vehicle.

12. The acceleration sensor assembly of claim 1, further comprising at least one housing cover forming a covering of the acceleration sensor assembly.

13. The acceleration sensor assembly of claim 1, wherein the acceleration sensor assembly is configured to be triggered in response to a ‘g’ force exceeding a threshold value during acceleration of the vehicle.

14. The acceleration sensor assembly of claim 1, wherein the acceleration sensor assembly is configured to return to its original state in response to a ‘g’ force falling below a threshold value.
